(19) United States
(12) Patent Application Publication
(10) Pub. No.: US 2019/0009819 A1
(43) Pub. Date: Jan. 10, 2019

(54) VEHICLE CONTROL SYSTEM, VEHICLE CONTROL METHOD AND VEHICLE CONTROL PROGRAM

(71) Applicant: HONDA MOTOR CO., LTD., Minato-ku, Tokyo (JP)

(72) Inventors: Atsushi Ishioka, Wako-shi (JP); Akira Mizutani, Wako-shi (JP)

(21) Appl. No.: 16/080,373

(22) PCT Filed: Mar. 8, 2017
(86) PCT No.: PCT/JP2017/009204

§ 371 Date: Aug. 28, 2018

(30) Foreign Application Priority Data
Mar. 15, 2016 (JP) 2016-051079

(51) Int. Cl. B62D 15/02

(52) U.S. Cl. CPC B62D 15/0255; G08G 1/16

(57) ABSTRACT

A vehicle control system includes a first setting part configured to set a target lane for traveling an own vehicle on the basis of a route to a set destination, a second setting part configured to temporarily set a lane between the traveling lane and the target lane as the target lane in a case a lane is present between the traveling lane in which the own vehicle is traveling and the target lane set by the first setting part, and a controller configured to automatically control at least the steering of the own vehicle such that the own vehicle travels in the target lane set by the first setting part or the second setting part.

### TECHNICAL FIELD

The present invention relates to a vehicle control system, a vehicle control method, and a vehicle control program.

Priority is claimed on Japanese Patent Application No. 2016-051079, filed Mar. 15, 2016, the content of which is incorporated herein by reference.

### BACKGROUND ART

In recent years, research has been performed on technology for automatically controlling at least one of acceleration and deceleration, and steering of an own vehicle (hereinafter, automated driving) such that the own vehicle travels along a route to a destination. In this regard, a vehicle assistance technology that identifies a route, which is searched by using road reference information indicating a road map, with lane reference information representing a details of the road map, and that generates guidance information for guiding a vehicle on the basis of the route identified by the lane reference information, has been disclosed (for example, see Patent Literature 1).

### CITATION LIST

### Patent Literature

[Patent Literature 1]

Japanese Unexamined Patent Application, First Publication No. 2006-266865

### SUMMARY OF INVENTION

### Technical Problem

However, in the technology of the related art, a lane along which a vehicle is made to travel may not be flexibly selected.

An aspect of the present invention is directed to providing a vehicle control system, a vehicle control method and a vehicle control program in which a lane along which a vehicle is made to travel is able to be selected flexibly according to a situation during traveling.

### Solution to Problem

(1) A vehicle control system according to an aspect of the present invention includes a first setting part that sets a target lane for traveling an own vehicle on the basis of a route to a set destination; a second setting part that temporarily sets a lane present between the traveling lane and the target lane as the target lane in a case a lane is present between the traveling lane in which the own vehicle is traveling and the target lane set by the first setting part; and a controller that automatically controls at least the steering of the own vehicle such that the own vehicle travels in the target lane set by the first setting part or the second setting part.

(2) In the aspect of (1), in a case the traveling lane of the own vehicle is different from the target lane set by the first setting part or the second setting part, the controller may change the lane of the own vehicle from the traveling lane to the target lane set by the first setting part or the second setting part by automatically controlling at least the steering of the own vehicle.

(3) In the aspect of (2), the controller may change the lane of the own vehicle to the lane that is temporarily set as the target lane by the second setting part, and then, change the lane of the own vehicle to the target lane set by the first setting part.

(4) In the aspect of (2) or (3), in a case a lane is still present between the traveling lane of the own vehicle and the target lane set by the first setting part after the controller has changed the lane of the own vehicle to the lane temporarily set as the target lane by the second setting part, the second setting part may temporarily set a lane present between the traveling lane and the target lane set by the first setting part as the target lane.

(5) A method installed in a computer configured to control a vehicle according to an aspect of the present invention includes setting a target lane for traveling an own vehicle on the basis of a route to a set destination; temporarily setting a lane present between a traveling lane of the own vehicle and the target lane as the target lane in a case a lane is present between the traveling lane in which the own vehicle is traveling and the set target lane; and automatically controlling at least steering of the own vehicle such that the own vehicle travels in the set target lane.

(6) A vehicle control program according to an aspect of the present invention is installed on an in-vehicle computer and configured to set a target lane for traveling an own vehicle on the basis of a route to a set destination; temporarily set a lane present between a traveling lane of the own vehicle and the target lane as the target lane in a case a lane is present between the traveling lane in which the own vehicle is traveling and the set target lane; and automatically controlling at least steering of the own vehicle such that the own vehicle travels in the set target lane.

### Advantageous Effects of Invention

According to the above-mentioned aspects (1) to (6), a lane in which a vehicle is traveling can be flexibly selected according to a situation during traveling.

### BRIEF DESCRIPTION OF DRAWINGS

FIG. 1 is a view showing components of an own vehicle.

FIG. 2 is a functional configuration view of the own vehicle.

FIG. 3 is a view showing an example of target lane information.

FIG. 4 is a view showing an aspect in which a relative position of an own vehicle with respect to a target lane is recognized by an own vehicle position recognition part.

FIG. 5 is a view showing a comparison of a scene in which a provisional target lane is not set as a comparative example and a scene in which a provisional target lane is set as in the present embodiment.

FIG. 6 is a view showing an example of an action plan generated in a certain section.

FIG. 7 is a view showing an example of a configuration of a trajectory generating part.

FIG. 8 is a view showing an example of candidates for a trajectory generated by a trajectory candidate generating part.

FIG. 9 is a flowchart showing an example of a flow of processing performed in a case a lane changing event is performed.

FIG. 10 is a view showing a state in which a target position is set.

FIG. 11 is a view showing a state in which a trajectory for a lane change is generated.

FIG. 12 is a flowchart showing an example of a flow of processing of an automated driving controller according to an embodiment.

### DESCRIPTION OF EMBODIMENTS

Hereinafter, embodiments of a vehicle control system, a vehicle control method and a vehicle control program of the present invention will be described with reference to the accompanying drawings.

### <Configuration>

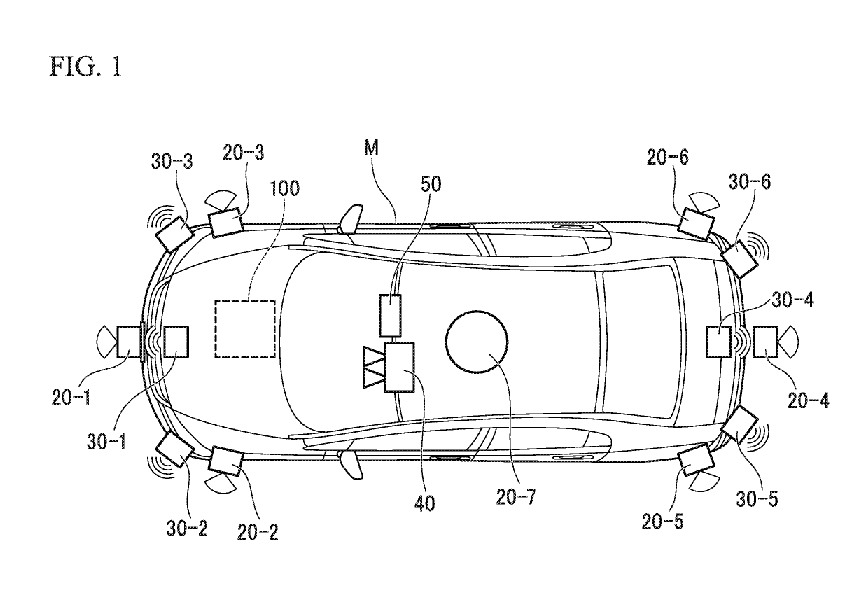

FIG. 1 is a view showing components of a vehicle on which a vehicle control system 100 of an embodiment is mounted (hereinafter, referred to as an own vehicle M). The vehicle on which the vehicle control system 100 is mounted is an automobile such as a two-wheeled, three-wheeled, or four-wheeled vehicle, or the like, and includes an automobile using an internal combustion engine such as a diesel engine, a gasoline engine, or the like, as a power source, an electric automobile using an electric motor as a power source, a hybrid automobile including both of an internal combustion engine and an electric motor, and so on. The electric automobile is driven using electric power discharged by a battery such as a secondary battery, a hydrogen fuel cell, a metal fuel cell, an alcohol fuel cell, or the like.

As shown in FIG. 1, sensors such as finders 20-1 to 20-7, radars 30-1 to 30-6, a camera 40, and so on, a navigation device 50, and the vehicle control system 100 are mounted on the own vehicle M.

The finders 20-1 to 20-7 use, for example, light detection and ranging or laser imaging detection and ranging (LIDAR) configured to measure scattered radiation with respect to radiated light and measure a distance to an object. For example, the finder 20-1 is attached to a front grille or the like, and the finders 20-2 and 20-3 are attached to side surfaces of a vehicle body, door mirrors, the insides of headlights, the vicinity of side lights, or the like. The finder 20-4 is attached to a trunk lid or the like, and the finders 20-5 and 20-6 are attached to side surfaces of the vehicle body, insides of tail lamps, or the like. The above-mentioned finders 20-1 to 20-6 have, for example, detection regions of about 150 degrees in a horizontal direction. In addition, the finder 20-7 is attached to a roof or the like.

The finder 20-7 has, for example, a detection region of 360 degrees in the horizontal direction.

The radars 30-1 and 30-4 are, for example, long-distance millimeter wave radars having a detection region in a depth direction that is wider than that of other radars. In addition, the radars 30-2, 30-3, 30-5 and 30-6 are middle-range millimeter wave radars having a detection region in the depth direction that is narrower than that of the radars 30-1 and 30-4.

Hereinafter, when the finders 20-1 to 20-7 are not specifically distinguished from each other, they are simply referred to as “the finder 20,” and when the radars 30-1 to 30-6 are not specifically distinguished from each other, they are simply referred to as “the radar 30.” The radar 30 detects an object using, for example, a frequency modulated continuous wave (FM-CW) method.

The camera 40 is a digital camera using an individual imaging element such as a charge coupled device (CCD), a complementary metal oxide semiconductor (CMOS), or the like. The camera 40 is attached to an upper section of a front windshield, a back surface of a rear-view mirror, or the like. The camera 40 periodically and repeatedly images a side in front of the own vehicle M, for example. The camera 40 may be a stereo camera including a plurality of cameras.

Further, the configuration shown in FIG. 1 is merely an example, and a part of the configuration may be omitted, or other components may be added.

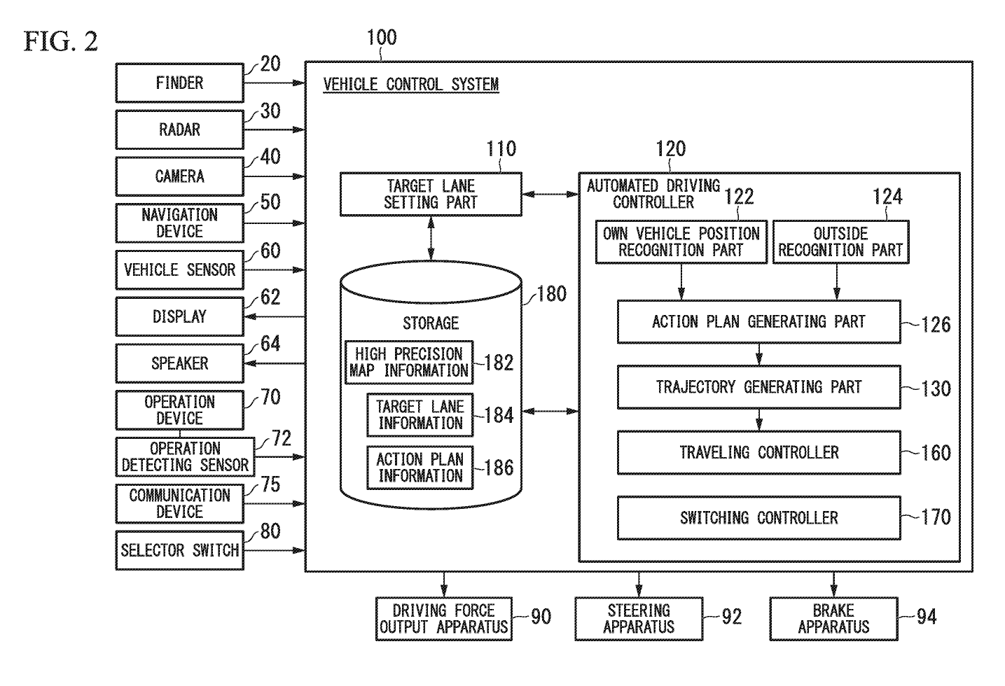

FIG. 2 is a functional configuration view of the own vehicle M on which the vehicle control system 100 according to the embodiment is mounted.

In addition to the finder 20, the radar 30 and the camera 40, the navigation device 50, a vehicle sensor 60, a display 62, a speaker 64, an operation device (a manipulator) 70, an operation detecting sensor 72, a communication device 75, a selector switch 80, a driving force output apparatus 90 configured to output a driving force for traveling, a steering apparatus 92, a brake apparatus 94 and the vehicle control system 100 are mounted on the own vehicle M. These devices or instruments are connected to each other by a multiplex communication line such as a controller area network (CAN) communication line or the like, a serial communication line, a wireless communication network, or the like.

The operation device that is exemplified is merely an example, and a joystick, a button, a dial switch, a graphical user interface (GUI) switch, or the like, may be mounted on the own vehicle M. Incidentally, the vehicle control system in the claims may include not only the vehicle control system 100 but also components (the finder 20 and the like) other than the vehicle control system 100 in the configuration shown in FIG. 2.

The navigation device 50 has a global navigation satellite system (GNSS) receiver, map information (navigation map), a touch panel type display device serving as a user interface, a speaker, a microphone, or the like. The navigation device 50 specifies a position of the own vehicle M using the GNSS receiver, and derives a route from the position to a destination designated by a user.

The route derived by the navigation device 50 is provided to a target lane setting part 110 of the vehicle control system 100. A position of the own vehicle M may be identified or complemented by the inertial navigation system (INS) using the output of the vehicle sensor 60.

In addition, the navigation device 50 performs guidance for the route to the destination using speech or navigation display when the vehicle control system 100 operates in a manual driving mode.

Further, the configuration for identifying the position of the own vehicle M may be installed independently from the navigation device 50.

In addition, the navigation device 50 may be realized by a function of a terminal device such as a smartphone, a tablet terminal, or the like, owned by a user. In this case, transmission and reception of information through wireless or wired communication between the terminal device and the vehicle control system 100 are performed.

The vehicle sensor 60 includes a vehicle speed sensor configured to detect a vehicle speed, an acceleration sensor configured to detect an acceleration, a yaw rate sensor configured to detect an angular speed around a vertical axis, an azimuth sensor configured to detect a direction of the own vehicle M, and so on.

The display 62 represents the information as an image. The display 62 may be, for example, a liquid crystal display (LCD), an organic electroluminescence (EL) display device, a head-up display, or the like. The display 62 may be a display included in the navigation device 50, or a display of an instrument panel that represents a state (a speed or the like) of the own vehicle M. The speaker 64 outputs the information as speech.

The operation device 70 includes operators such as an accelerator pedal, a brake pedal, a shift lever (or a paddle shift), a steering wheel, and so on.

The operation detecting sensor 72 is a sensor configured to detect an operation amount of the operation device 70, and includes sensors such as an accelerator opening degree sensor, a brake pedal depression amount sensor (a brake switch), a shift position sensor, a steering angle sensor (or a steering torque sensor), and so on. For example, the operation detecting sensor 72 may output an accelerator opening degree, a brake pedal depression amount, a shift position, a steering angle, a steering torque, and so on, as detection results to the vehicle control system 100.

Further, instead of this, the detection result of the operation detecting sensor 72 according to the driving mode may be directly output to the driving force output apparatus 90, the steering apparatus 92 or the brake apparatus 94.

The communication device 75 performs wireless communication using an inter-vehicle communication network or the like using a cellular communication network, a Wi-Fi network, a dedicated short range communications (DSRC), or the like. The communication device 75 acquires information from an information providing server by being connected with the Internet via, for example, a radio base station.

The selector switch 80 is a switch operated by an occupant in the vehicle. The selector switch 80 receives the operation of the occupant in the vehicle, generates a driving mode designating signal that designates a driving mode of the own vehicle M, and outputs the signal to a switching controller 170. The selector switch 80 may be either a GUI switch or a mechanical switch.

The driving force output apparatus 90 outputs a traveling driving force (torque) for moving the vehicle to driving wheels. The driving force output apparatus 90 includes, for example, an engine, a gear box and an engine electronic control unit (ECU) configured to control the engine when the own vehicle M is an automobile using an internal combustion engine as a power source. In addition, when the own vehicle M is an electric automobile using an electric motor as a power source, the driving force output apparatus 90 includes a traveling motor and a motor ECU configured to control the traveling motor. In addition, when the own vehicle M is a hybrid automobile, the driving force output apparatus 90 includes an engine, a gear box, an engine ECU, a traveling motor and a motor ECU.

When the driving force output apparatus 90 includes only an engine, the engine ECU adjusts a throttle opening degree of the engine, a shift stage, or the like, according to the information input from a traveling controller 160, which will be described below.

When the driving force output apparatus 90 includes only the traveling motor, the motor ECU adjusts a duty ratio of a PWM signal provided to the traveling motor according to the information input from the traveling controller 160.

When the driving force output apparatus 90 includes an engine and the traveling motor, the engine ECU and the motor ECU cooperate with each other to control the traveling driving force according to the information input from the traveling controller 160.

The steering apparatus 92 includes, for example, a steering ECU and an electric motor. The electric motor changes a direction of a steered wheel by applying a force to, for example, a rack and pinion mechanism.

The steering ECU changes a direction of the steered wheel by driving the electric motor according to the information input from the vehicle control system 100 or information of a steering angle or a steering torque, which is input.

The brake apparatus 94 is an electric servo brake apparatus including, for example, a brake caliper, a cylinder configured to transmit a hydraulic pressure to the brake caliper, an electric motor configured to generate a hydraulic pressure in the cylinder, and a braking controller.

The braking controller of the electric servo brake apparatus controls the electric motor according to the information input from the traveling controller 160 such that a brake torque according to a braking operation is output to the wheels.

The electric servo brake apparatus may include a mechanism configured to transmit a hydraulic pressure generated by an operation of a brake pedal to a cylinder via a master cylinder as a backup.

Further, the brake apparatus 94 is not limited to the above-mentioned electric servo brake apparatus and may be an electronically controlled hydraulic brake apparatus. The electronically controlled hydraulic brake apparatus controls an actuator according to the information input from the traveling controller 160, and transmits the hydraulic pressure of the master cylinder to the cylinder.

In addition, the brake apparatus 94 may include a regeneration brake using the traveling motor that may be included in the driving force output apparatus 90. The regeneration brake uses the electric power generated by the traveling motor that may be included in the driving force output apparatus 90.

### [Vehicle Control System]

Hereinafter, the vehicle control system 100 will be described. The vehicle control system 100 is realized by, for example, one processor or more, or hardware having the same function. The vehicle control system 100 may be configured by assembling a processor such as a central processing unit (CPU) or the like, a storage device, and an ECU, to which a communication interface is connected via an internal bus, or a micro processing unit (MPU), or the like.

The vehicle control system 100 includes, for example, the target lane setting part 110, an automated driving controller 120 and a storage 180.

The automated driving controller 120 includes, for example, an own vehicle position recognition part 122, an outside recognition part 124, an action plan generating part 126, a trajectory generating part 130, the traveling controller 160 and the switching controller 170.

The target lane setting part 110 is an example of “a first setting part,” and the action plan generating part 126 is an example of “a second setting part.”

In addition, the trajectory generating part 130 and the traveling controller 160 are an example of “a controller.”

Some or all of parts of the target lane setting part 110 and the automated driving controller 120 are realized by the processor executing the program (software). In addition, some or all of these may be realized by hardware such as a large scale integration (LSI), an application specific integrated circuit (ASIC), or the like, and may be realized by combining software and hardware.

For example, information such as high precision map information 182, target lane information 184, action plan information 186, and so on, are stored in the storage 180.

The storage 180 is realized by a read only memory (ROM), a random access memory (RAM), a hard disk drive (HDD), a flash memory, or the like. The program performed by the processor may be previously stored in the storage 180 or may be downloaded from an external device via in-vehicle Internet equipment or the like.

In addition, the program may be installed on the storage 180 by mounting a portable recording medium, on which a program is stored, on a drive device (not shown).

In addition, the vehicle control system 100 may be distributed over a plurality of computer devices.

The target lane setting part 110 is realized by, for example, an MPU. The target lane setting part 110 divides a route provided from the navigation device 50 into a plurality of blocks B(n: n is a natural number) (for example, partitioning every 100 [m] in a vehicle traveling direction), and sets a target lane to each of the blocks B(n) with reference to the high precision map information 182.

Further, division intervals of the blocks B(n) may be equal to each other or may be unequal.

The target lane setting part 110 makes a decision using the map, for example, regarding the lane number from the left on which the own vehicle will travel. For example, in a case branching points or merging points exists on the route of the own vehicle, the target lane setting section 110 sets target lanes such that the own vehicle M can travel on a reasonable traveling route for reaching branched destinations.

The target lane setting part 110 sets a target lane on the road in the map shown by the high precision map information 182, and stores the high precision map information 182 to which the target lane is set in each of the blocks B(n) on the storage 180 as the target lane information 184.

The high precision map information 182 is map information that is more precise than that in a navigation map provided in the navigation device 50. The high precision map information 182 includes, for example, information of a center of the traveling lane, information of a boundary of the traveling lane, or the like.

In addition, the high precision map information 182 may include road information, traffic regulations information, address information (address/zip code), facilities information, telephone number information, and so on. The road information includes information that represents types of road such as an expressway, a toll road, a national road or a prefectural road, and information such as the number of lanes of the road, a width of each lane, a gradient of the road, a position of the road (three-dimensional coordinates including a longitude, a latitude and a height), a curvature of a curve of the lane, positions of junctions and interchange points of the lane, marks provided on the road, and so on.

The traffic regulations information includes information on lanes being blocked due to roadwork, traffic accidents, traffic congestion, or the like.

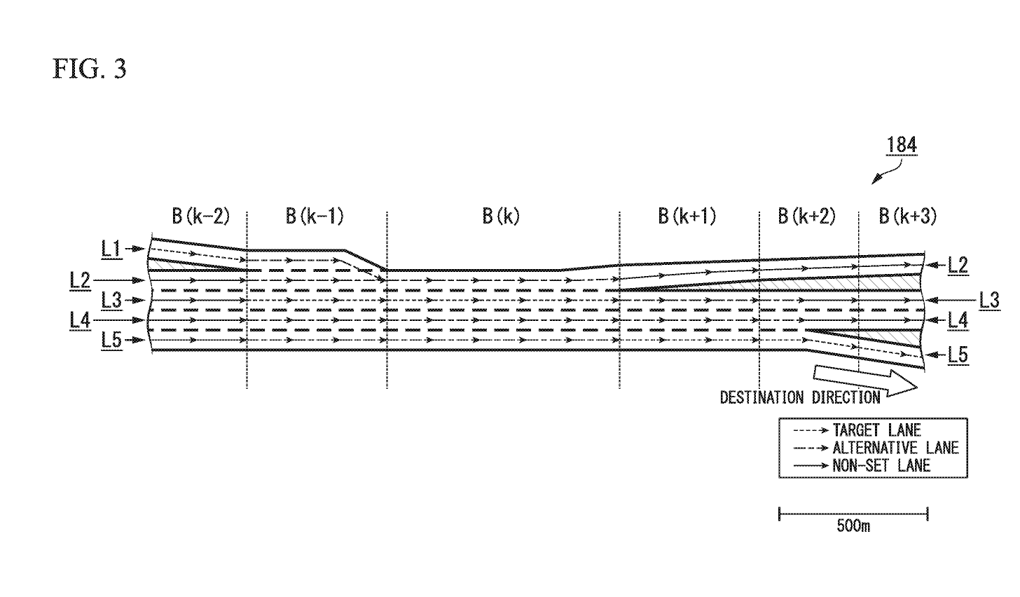

FIG. 3 is a view showing an example of the target lane information 184.

An alternative lane shown in FIG. 3 represents a lane that can be temporarily set to a target lane through the processing of the action plan generating part 126, which will be described below.

In addition, a non-set lane represents a lane that is not set as a target lane. For example, the target lane setting part 110 sets the target lane on the high precision map according to the following conditions (1) to (4).

Further, the following conditions are merely examples, some of the conditions may be omitted, and other additional conditions may be added.

(1) In a case there are a plurality of candidate lanes for setting the target lane, the leftmost lane in a direction perpendicular to the advance direction of the own vehicle M is set as the target lane.

(2) In a case the lane narrows or branches off within a predetermined distance (for example, 2 km) in front of the vehicle, another lane other than this lane is set as the target lane.

(3) In a case the direction to a destination is following the lane branching off, at a point a predetermined distance (for example, 1 km) before the branching point thereto, a lane after branched off or a lane adjacent to the lane after branched off is set as the target lane.

(4) With respect to a junction of lanes, a main lane is set as the target lane at a point where the own vehicle is joinable to the main line from a branch lane.

In the cases following the above-mentioned conditions (1) to (4), there are cases in which the target lane setting part 110 sets a lane separated from the previously set target lane by one or a plurality of lanes as a new target lane, a case in which the target lane is continued to be set on the same lane, and a case in which an adjacent lane of the previously set target lane is set as the new target lane.

That is, there is a case in which the target lane setting part 110 sets the target lane without taking into account neighboring relationships between lanes.

In the example shown in FIG. 3, in a section of the block B(k−2), since a lane L1 in which the own vehicle M currently travels is a single lane, the lane L1 is set as the target lane.

In addition, while a plurality of lanes are present in sections of the blocks B(k−1) and B(k), since a branching point is present in front in a lane L2 on the leftmost side of the main lane, a lane L3 on the leftmost side except the lane L2 is set as the target lane.

In addition, in a section of the block B(k+1), since the branching point is present in the block B(k+2) of the next section and a lane L5 after branched off follows a direction to the destination, a lane L4 adjacent to the lane L5 is set as the target lane.

The an own vehicle position recognition part 122 of the automated driving controller 120 recognizes a lane (a traveling lane) in which the own vehicle M is traveling, on the basis of the high precision map information 182 stored in the storage 180, and information input from the finder 20, the radar 30, the camera 40, the navigation device 50 or the vehicle sensor 60.

For example, the own vehicle position recognition part 122 recognizes which lane is the target lane by comparing a pattern of road lane markings recognized from the high precision map information 182 (for example, pattern of solid lines and broken lines) with a pattern of road lane markings adjacent to the own vehicle M recognized from an image imaged by the camera 40. In this recognition, a position of the own vehicle M acquired from the navigation device 50 or a processing result from the INS may be applied.

In addition, the own vehicle position recognition part 122 recognizes a relative position of the own vehicle M with respect to the recognized traveling lane on the basis of the high precision map information 182 and the information from the various sensors.

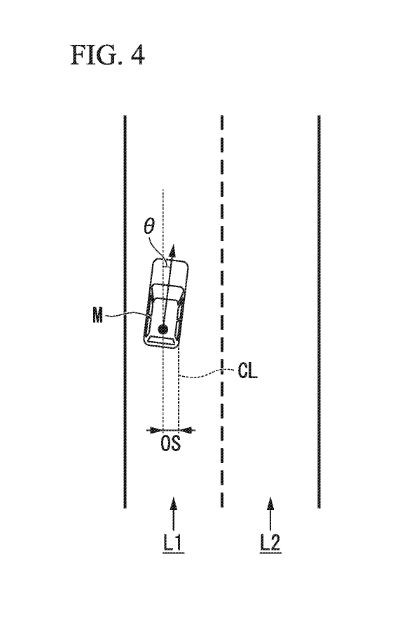

FIG. 4 is a view showing a state in which a relative position of the own vehicle M with respect to the target lane L1 is recognized by the own vehicle position recognition part 122. The an own vehicle position recognition part 122 recognizes, for example, an separation OS of the reference point (for example, a center of gravity or a center of a rear wheel shaft) of the own vehicle M from a target lane center CL and an angle θ with respect to a line connecting the target lane center CL in the advancing direction of the own vehicle M as a relative position of the own vehicle M with respect to the target lane L1.

Further, instead of this, the own vehicle position recognition part 122 may recognize a position or the like of a reference point of the own vehicle M with respect to any one of the side end portions of the own traffic lane L1 as a relative position of the own vehicle M with respect to the target lane. The relative position of the own vehicle M recognized by the own vehicle position recognition part 122 is provided to the target lane setting part 110.

The outside recognition part 124 recognizes a position of a neighboring vehicle and a state such as a speed, an acceleration, or the like, on the basis of the information input from the finder 20, the radar 30, the camera 40, and so on.

The neighboring vehicle is, for example, a vehicle that is traveling around the own vehicle M, and a vehicle that is traveling in the same direction as the own vehicle M. The position of the neighboring vehicle may be displayed as a reference point of a center of gravity, a corner, or the like, of another vehicle, and may be displayed as a region expressed as a profile of another vehicle.

“The state” of the neighboring vehicle may include whether the acceleration and the lane change of the neighboring vehicle is performed (or whether the lane change is going to be performed) that is grasped on the basis of the information of the various instruments.

In addition, the outside recognition part 124 may recognize positions of a guard rail, an electric pole, a parked vehicle, a pedestrian, and other substances, in addition to the neighboring vehicle.

The action plan generating part 126 sets a start point of automated driving and/or a destination of the automated driving. The start point of the automated driving may be a current position of the own vehicle M or may be a point at which an operation indicating the automated driving was made. The action plan generating part 126 generates an action plan in a section between the start point and the destination of the automated driving with reference to the target lane information 184. Further, there is no limitation thereto, and the action plan generating part 126 may generate an action plan in an arbitrary section.

The action plan is constituted by, for example, a plurality of events, which are performed in sequence.

The event includes, for example, a deceleration event of decelerating the own vehicle M, an acceleration event of accelerating the own vehicle M, a lane keeping event of causing the own vehicle M to travel not to deviate from the target lane, a lane changing event of changing the target lane, a passing event of causing the own vehicle M to pass a preceding vehicle, a branching event of changing to a predetermined lane or causing the own vehicle M to travel not to deviate from the current target lane at the branching point, a joining event of accelerating and decelerating the own vehicle M and changing the target lane in the junction lane for joining to the main lane, or the like.

The action plan generating part 126 sets the lane changing event, the branching event or the joining event at a place where the target lane set by the target lane setting part 110 is switched.

The information that indicates the action plan generated by the action plan generating part 126 is stored in the storage 180 as the action plan information 186.

In addition, the action plan generating part 126 temporarily sets another lane as the target lane on the basis of a neighborhood relation between a traveling lane in which the own vehicle M currently travels and the target lane set by the target lane setting part 110. Hereinafter, the other lane temporarily set as the target lane will be described while being referred to as “a provisional target lane.”

For example, the action plan generating part 126 sets a lane present between the traveling lane and the target lane as a provisional target lane with reference to the target lane information 184 in a case the target lane is set by skipping one or a plurality of lanes from the traveling lane.

The action plan generating part 126 may set a plurality of event candidates in the section in which the provisional target lane is set. Then, the action plan generating part 126 selects one event from the plurality of event candidates set in the section on the basis of the state of the neighboring vehicle recognized by the outside recognition part or presence of a substance such as an obstacle or the like.

That is, the action plan generating part 126 sets all the events that have probability obtained according to surrounding situations in the section in which the provisional target lane is set as the candidates, and dynamically changes an action plan by selecting a timely event from the candidates on the basis of the recognition result by the outside recognition part.

For example, the action plan generating part 126 selects an appropriate event from the previously set event candidates in a case a speed of the neighboring vehicle recognized by the outside recognition part 124 while the vehicle is traveling exceeds a threshold value or a moving direction of the neighboring vehicle that is traveling in the adjacent lane close to the own traffic lane is oriented toward a direction of the own traffic lane.

For example, in the case in which the lane changing event is set, when it is determined by the recognition result of the outside recognition part 124 that the vehicle has proceeded at a speed higher than the threshold value from behind the lane to which the lane is changed during the lane keeping event, the action plan generating part 126 may select a deceleration event, a lane keeping event, or the like, from the preset event candidates, and may change the event to be performed to the selected one.

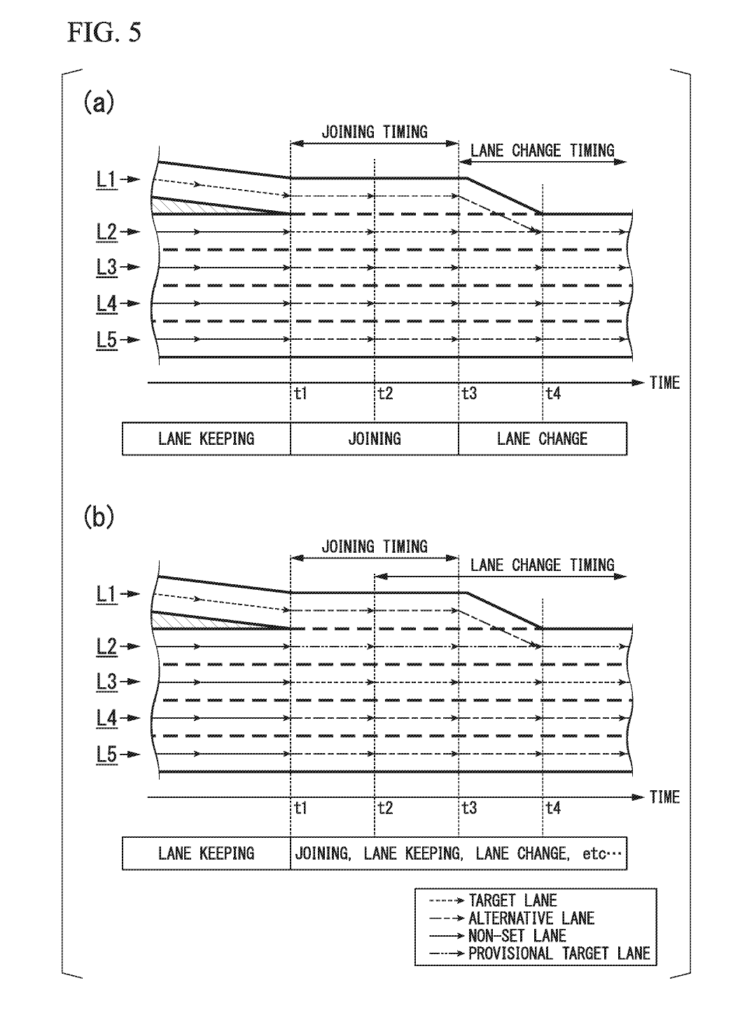

FIG. 5 is a view showing a comparison of a scene in which a provisional target lane is not set as a comparative example and a scene in which a provisional target lane is set as in the present embodiment. FIG. 5(a) shows the comparative example in which the provisional target lane is not set, and FIG. 5(b) shows an example of the embodiment.

For example, in the comparative example of FIG. 5(a), in a case the own vehicle M is moved to the lane L3 of the main lane from the branch lane L1, the target lane is set in sequence of the lanes L1, L2 and L3.

In this case, for example, in a duration from a timing t1 when the target lane is switched from the lane L1 to the lane L2 to a timing t3 when the target lane is switched from the lane L2 to the lane L3, the own vehicle M is controlled to join the lane L2.

However, since the joining timing depends on a speed of the neighboring vehicle that is traveling in the lane L2, an inter-vehicle distance between the vehicles, or the like, there is a possibility that the vehicle is not moved to the lane even at the timing t3.

In addition, since the own vehicle M is traveling according to a switching timing of the target lane, there is a possibility that a violent joining, lane change, or the like happens, and an occupant of the own vehicle M may be frighten.

In addition, before the timing t3 when the target lane is switched, even in a case it is possible to change the lane from the lane L2 to the lane L3, it is necessary to wait for implementation of the event until a predetermined time (in this case, t3).

On the other hand, in the embodiment in FIG. 5(b), the target lane setting part 110 sets only a lane to be finally arrived as the target lane without considering the neighborhood relation between the lanes in a case the plurality of lanes set as the target lane are present, and the action plan generating part 126 sets the other lanes for arriving to the target lane set by the target lane setting part 110 as a provisional target lane. For this reason, it is possible to provide a certain range with respect to deciding the implementation timing for each event.

For example, the joining event to the lane L2 may be performed until a time t4, and the own vehicle M is controlled to join the provisional target lane L2 at any timing in a duration until the time t4. In the duration, not only the joining event is set but also other events such as lane keeping or the like is set, an operation such as temporarily keeping the lane till the appropriate joining timing can be performed.

In addition, the lane changing event with respect to the lane L3 may be performed after the timing when the joining event is performed, and for example, when the joining event is performed at the timing of a time t2, the own vehicle M is controlled to change the lane to the original target lane L3 at any timing after the time t2.

Accordingly, after the time t2, it is not necessary for the lane changing event to be performed immediately, and the lane keeping event or the like may be appropriately performed.

Accordingly, the vehicle control system 100 can improve a realization of the action plan by flexibly selecting the lane in the route to the destination.

In addition, the vehicle control system 100 can carefully change the traveling lanes one by one according to surrounding circumstances at the time of the traveling. For this reason, it is possible to perform automated traveling of the own vehicle M more safely.

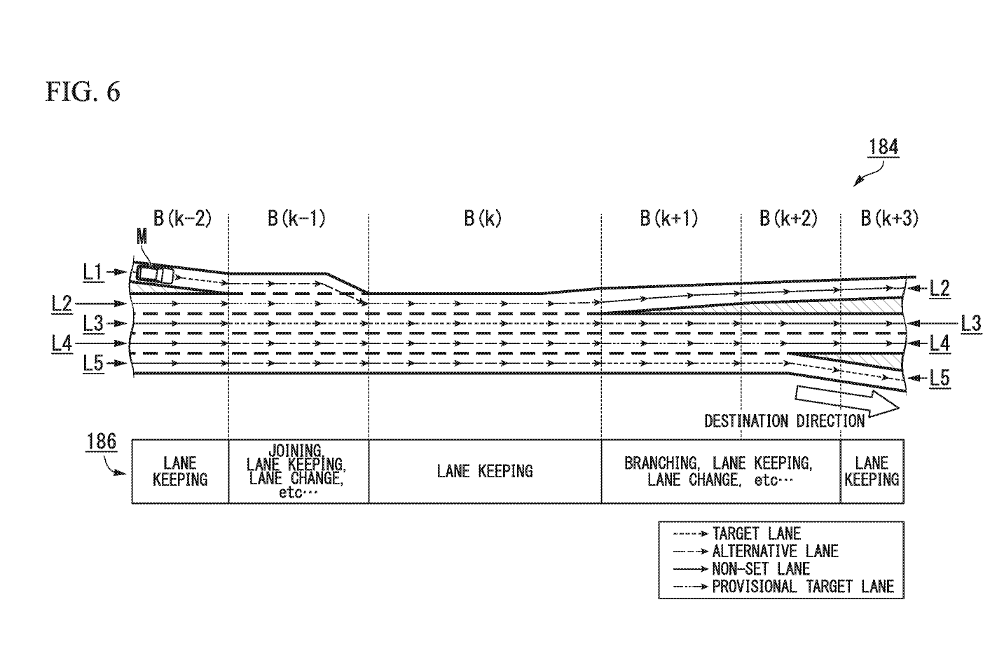

FIG. 6 is a view showing an example of an action plan generated in a certain section.

As shown in FIG. 6, the action plan generating part 126 generates an action plan required for causing the own vehicle M to travel on the target lane shown by the target lane information 184. Here, the action plan generating part 126 sets a plurality of event candidates in the provisional target lane, and dynamically changes the event according to the surrounding circumstances.

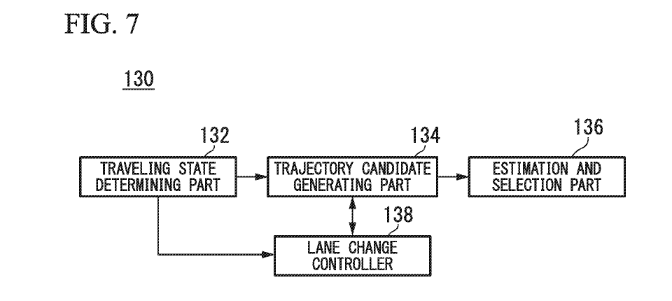

FIG. 7 is a view showing an example of the configuration of the trajectory generating part 130. The trajectory generating part 130 includes, for example, a traveling state determining part 132, a trajectory candidate generating part 134, an estimation and selection part 136 and a lane change controller 138.

The traveling state determining part 132 determines any one of traveling states of constant speed traveling, following traveling, deceleration traveling, curve traveling, obstacle avoidance traveling, and so on, in a case the lane keeping event is performed.

For example, the traveling state determining part 132 determines the traveling state as the constant speed traveling in a case another vehicle is not present in front of the own vehicle M.

In addition, the traveling state determining part 132 determines the traveling state as the following traveling in a case the own vehicle travels to follow a preceding vehicle.

In addition, the traveling state determining part 132 determines the traveling state as the deceleration traveling in a case deceleration of the preceding vehicle is recognized by the outside recognition part 124 or an event such as stopping, parking, or the like, is performed.

In addition, the traveling state determining part 132 determines the traveling state as the curve traveling in a case the fact that the own vehicle M has approached a curved road is recognized by the outside recognition part 124.

In addition, the traveling state determining part 132 determines the traveling state as the obstacle avoidance traveling in a case an obstacle in front of the own vehicle M is recognized by the outside recognition part 124.

The trajectory candidate generating part 134 generates trajectory candidates on the basis of the traveling state determined by the traveling state determining part 132. The trajectory in the embodiment is collection of target positions (trajectory points) at which a reference point (for example, a center of gravity or a center of a rear wheel shaft) of the own vehicle M arrives at a predetermined time in the future (or each predetermined traveling distance).

The trajectory candidate generating part 134 calculates a target speed of the own vehicle M on the basis of at least a speed of an object OB present in front of the own vehicle M recognized by the outside recognition part 124 and a distance between the own vehicle M and the object OB.

The trajectory candidate generating part 134 generates one trajectory or more on the basis of the calculated target speed. The object OB includes a preceding vehicle, points such as a junction point, a branching point, a target point, and so on, a substance such as an obstacle or the like, and so on.

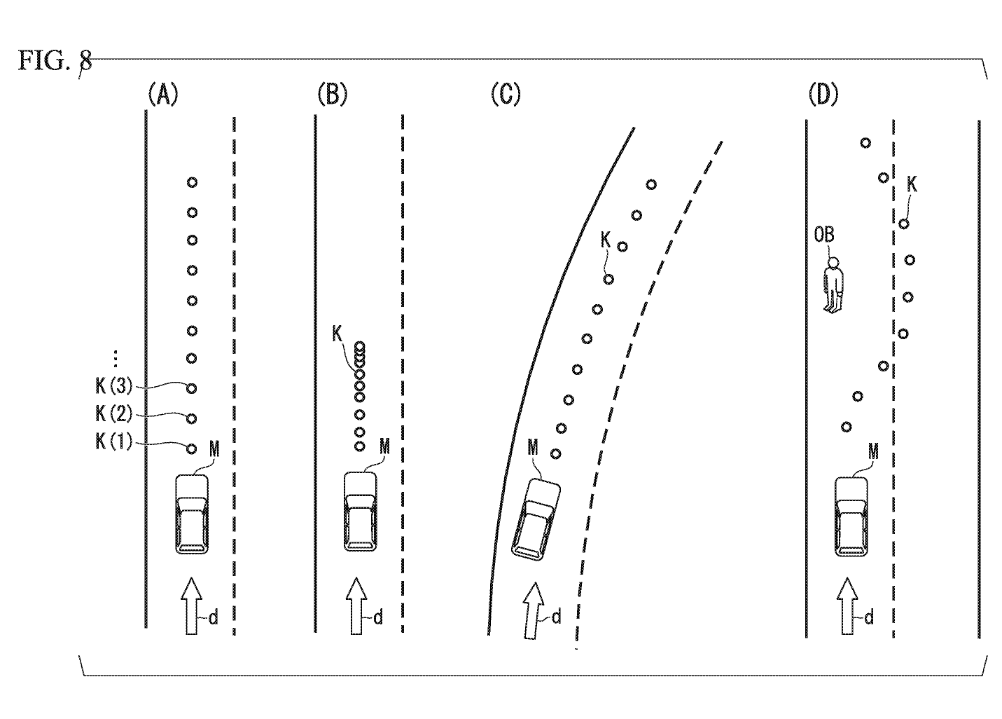

FIG. 8 is a view showing an example of trajectory candidates generated by the trajectory candidate generating part 134.

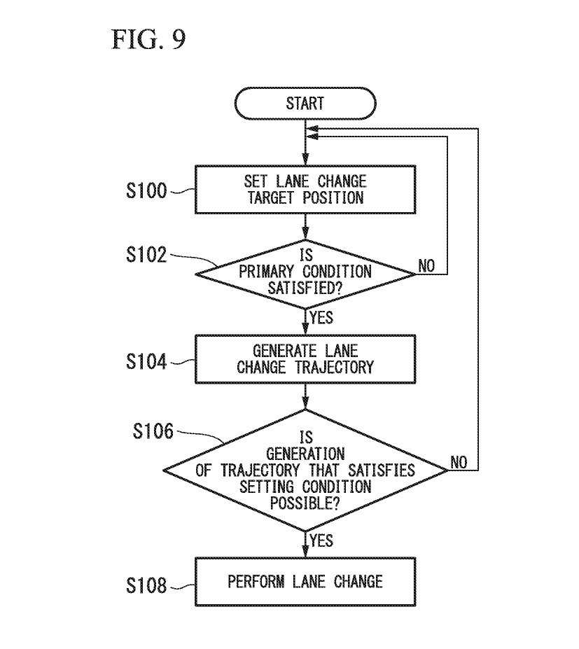

Further, in FIG. 8 and the following FIG. 9, only a typical trajectory among a plurality of set and obtained trajectory candidates or a trajectory selected by the estimation and selection part 136 is marked and described. As shown in FIG. 8(A), for example, the trajectory candidate generating part 134 sets the trajectory points referred to as K(1), K(2), K(3), . . . whenever a predetermined time At elapses from the current time with reference to the current position of the own vehicle M. Hereinafter, when the trajectory points are not specifically distinguished with each other, they may be simply referred to as “a trajectory point K.”

In a case the traveling state is determined as constant speed traveling by the traveling state determining part 132, as shown in FIG. 8(A), the trajectory candidate generating part 134 sets the plurality of trajectory points K at equal intervals. In a case such a simple trajectory is generated, the trajectory candidate generating part 134 may generate only one trajectory.

In a case the traveling state is determined as the deceleration traveling by the traveling state determining part 132 (including also in a case the preceding vehicle in the following traveling is decelerated), as shown in FIG. 8(B), the trajectory candidate generating part 134 generates trajectories by widening the intervals of the trajectory point K to which an arrival time is earlier and by narrowing the intervals of the trajectory point K to which an arrival time is later. In this case, the preceding vehicle may be set as the object OB, or points such as a junction point, a branching point, a target point, or the like, an obstacle, and so on, other than the preceding vehicle, may be set as the object OB. Accordingly, since the trajectory point K at which an arrival time from the own vehicle M is later approaches the current position of the own vehicle M, the traveling controller 160, which will be described below, decelerates the own vehicle M.

In a case the traveling state is determined as the curve traveling by the traveling state determining part 132, as shown in FIG. 8(C), the trajectory candidate generating part 134 disposes the plurality of trajectory points K according to a curvature of the road while changing a lateral position of the own vehicle M with respect to the advance direction (a position in a lane width direction).

In addition, as shown in FIG. 8(D), when the obstacle OB such as a human, a stopped vehicle, or the like, is present on the road in front of the own vehicle M, the trajectory candidate generating part 134 disposes the plurality of trajectory points K such that the own vehicle M travels while avoiding the obstacle OB.

The estimation and selection part 136 performs estimation in two viewpoints of, for example, planning and safety with respect to the trajectory candidates generated by the trajectory candidate generating part 134, and selects the trajectory to output to the traveling controller 160. From a viewpoint of the planning, for example, a trajectory in which a trackability with respect to the already generated plan (for example, an action plan) is high and the entire length of the trajectory is short is highly estimated. For example, in a case it is preferable to change the lane in a rightward direction, a trajectory in which the lane is first changed in a leftward direction and then returning in the rightward direction is lowly estimated. From a viewpoint of safety, for example, the safety is highly estimated as a distance between the own vehicle M and the substance (the neighboring vehicle or the like) is larger, and a variation amount of an acceleration and deceleration, a steering angle, or the like, is smaller.

The lane change controller 138 is operated in a case the lane changing event, the branching event, the joining event, and so on, are performed, i.e., in a case a lane change in a broad sense is performed.

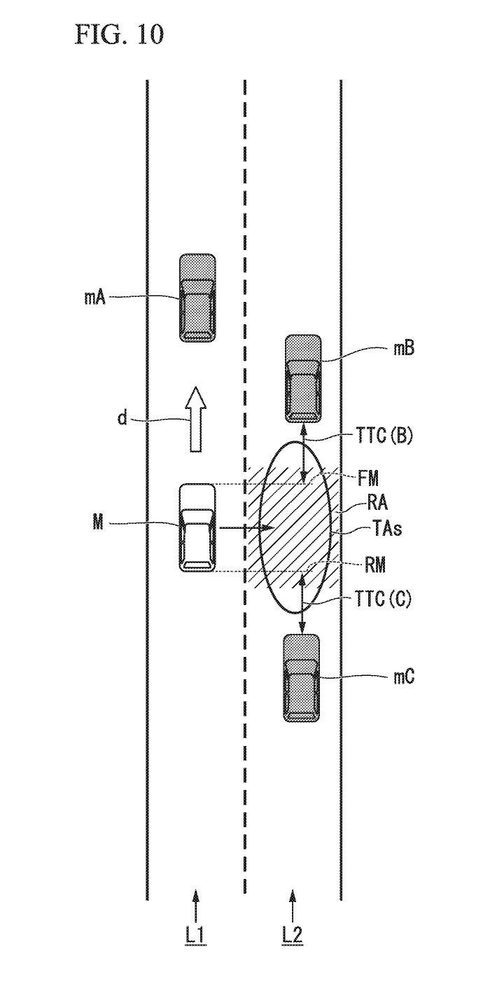

FIG. 9 is a flowchart showing an example of a flow of processing performed in a case the lane changing event is performed. The processing will be described with reference to FIGS. 9 and 10.

First, the lane change controller 138 selects two neighboring vehicles from the neighboring vehicles that travel in the adjacent lanes to which the lane is changed, among the lanes adjacent to the lane where the own vehicle M is traveling (own traffic lane), and sets a target position TA between the neighboring vehicles (step S100).

Hereinafter, a neighboring vehicle that is traveling immediately in front of the target position TA in the adjacent lane is referred and described to as a front reference vehicle mB, and a neighboring vehicle that is traveling immediately behind the target position TA in the adjacent lane is referred and described to as a rear reference vehicle mC. The target position TA is a relative position based on a positional relation between the own vehicle M, the front reference vehicle mB and the rear reference vehicle mC.

FIG. 10 is a view showing an aspect in which the target position TA is set. In FIG. 10, mA represents a preceding vehicle, mB represents a front reference vehicle, and mC represents a rear reference vehicle. In addition, an arrow d represents an advance (traveling) direction of the own vehicle M, L1 represents own traffic lane, and L2 represents an adjacent lane.

In the case of the example in FIG. 10, the lane change controller 138 sets the target position TA between the front reference vehicle mB and the rear reference vehicle mC on the adjacent lane L2.

Next, the lane change controller 138 determines whether a primary condition is satisfied to determine whether the lane change to the target position TA (i.e., between the front reference vehicle mB and the rear reference vehicle mC) is possible (step S102).

In the primary condition, for example, there is no neighboring vehicle in a forbidden region RA provided in the adjacent lane, and the time to collision (TTC) between the own vehicle M, and the front reference vehicle mB and the rear reference vehicle mC is larger than the threshold value.

Further, the determination condition is an example in a case the target position TA is set to a side of the own vehicle M.

In a case the primary condition is not satisfied, the lane change controller 138 returns the processing to step S100 and resets the target position TA.

Here, the speed control for moving the vehicle to the side of the target position TA may be performed by waiting until the timing when the target position TA can be set to satisfy the primary condition or changing the target position TA.

As shown in FIG. 10, for example, the lane change controller 138 projects the own vehicle M to the lane L2 to which the lane is changed, and sets the forbidden region RA that has a slight buffer distance in a forward and rearward direction. The forbidden region RA is set as a region extending from one end to the other end of the lane L2 in the lateral direction.

In a case the neighboring vehicle is not present in the forbidden region RA, the lane change controller 138 assumes, for example, an extension line FM and an extension line RM virtually extending a front end and a rear end of the own vehicle M toward the lane L2 to which the lane is changed.

The lane change controller 138 calculates a time to collision TTC(B) between the extension line FM and the front reference vehicle mB and a rear reference vehicle TTC(C) between the extension line RM and the rear reference vehicle mC.

The time to collision TTC(B) is a time derived by dividing a distance between the extension line FM and the front reference vehicle mB by a relative speed between the own vehicle M and the front reference vehicle mB.

The time to collision TTC(C) is a time derived by dividing a distance between the extension line RM and the rear reference vehicle mC by a relative speed between the own vehicle M and the rear reference vehicle mC.

The trajectory candidate generating part 134 determines that the primary condition is satisfied when the time to collision TTC(B) is larger than a threshold value Th(B) and the time to collision TTC(C) is larger than a threshold value Th(C).

The threshold values Th(B) and Th(C) may be the same value or may be different values.

In a case the primary condition is satisfied, the lane change controller 138 generates the trajectory candidate for the lane change in the trajectory candidate generating part 134 (step S104).

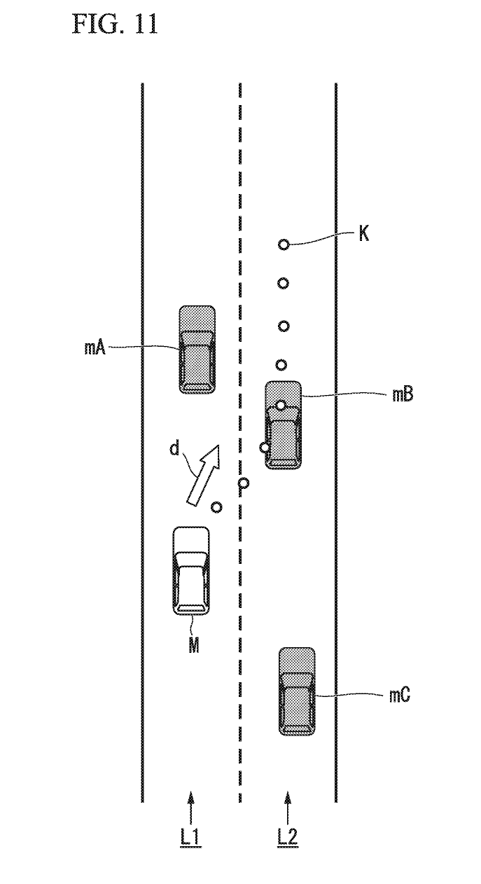

FIG. 11 is a view showing a state in which a trajectory for a lane change is generated. For example, the trajectory candidate generating part 134 assumes that a preceding vehicle mA, the front reference vehicle mB and the rear reference vehicle mC travel at a predetermined speed model, and generates the trajectory candidate so that the own vehicle M does not interfere or contact with the preceding vehicle mA and is disposed between the front reference vehicle mB and the rear reference vehicle mC at a certain time in the future on the basis of the speed model of the three vehicles and the speed of the own vehicle M.

For example, the trajectory candidate generating part 134 smoothly connects lines from a current position of the own vehicle M to a position of the front reference vehicle mB at a certain time in the future, a center of the lane to which the own vehicle M changes the lane and a terminal point of the lane changing by using a polynomial curve line such as a spline curve line or the like, and disposes a predetermined number of trajectory points K on the curve line at equal intervals or non-equal intervals.

Here, the trajectory candidate generating part 134 generates the trajectory such that at least one of the trajectory points K is disposed in the target position TA.

In a case the primary condition is not satisfied, the lane change controller 138 may return to the above-mentioned processing in step S100 and set a new target position TA.

For example, the lane change controller 138 sets the rear reference vehicle mC referenced when the target position TA is set as a new front reference vehicle mB, sets the vehicle present behind the newly set front reference vehicle mB as a new rear reference vehicle mC, and resets the target position TA between the front reference vehicle mB and the rear reference vehicle mC, which are reset.

Further, similarly, the lane change controller 138 may set the front reference vehicle mB referenced when the target position TA is set as a new rear reference vehicle mC, set the vehicle present in front of the newly set rear reference vehicle mC as a new front reference vehicle mB, and reset the target position TA between the front reference vehicle mB and the rear reference vehicle mC, which are reset.

Accordingly, the trajectory candidate generating part 134 generates a trajectory that changes a lane of the own vehicle M between the front reference vehicle mB and the rear reference vehicle mC, which are reset.

Next, the estimation and selection part 136 determines whether trajectory candidates that satisfy the setting conditions are generated (step S106). The setting conditions are estimation values equal to or larger than the threshold value, for example, from the viewpoint of the above-mentioned planning or safety.

In a case the trajectory candidates that satisfy the setting conditions can be generated, for example, the estimation and selection part 136 selects the trajectory candidate having a highest estimation value, outputs the trajectory information to the traveling controller 160 and performs the lane change (step S108).

Meanwhile, in a case the trajectory that satisfies the setting conditions cannot be generated, the processing returns to step S100. Here, like the case in which negative determination is obtained in step S102, the processing may be in a standby state or the target position TA may be reset.

The traveling controller 160 controls the driving force output apparatus 90, the steering apparatus 92 and the brake apparatus 94 such that the own vehicle M passes through the trajectory generated by the trajectory candidate generating part 134 at a planned time.

The switching controller 170 switches a driving mode on the basis of not only the driving mode designating signal input from the selector switch 80 but also an operation of indicating acceleration and deceleration or steering with respect to the operation device 70.

For example, the switching controller 170 switches the automated driving mode to the manual driving mode in a case a state in which an operation amount input from the operation detecting sensor 72 exceeds the threshold value is continued for a reference time or more.

In addition, the switching controller 170 switches the driving mode from the automated driving mode to the manual driving mode in the vicinity of the destination of the automated driving.

The switching controller 170 performs the switching on the basis of the driving mode designating signal input from the selector switch 80 when the manual driving mode is switched to the automated driving mode. In addition, after the automated driving mode is switched to the manual driving mode, the control of returning to the automated driving mode may be performed when an operation of instructing the acceleration, the deceleration or the steering with respect to the operation device 70 is not detected for a predetermined time.

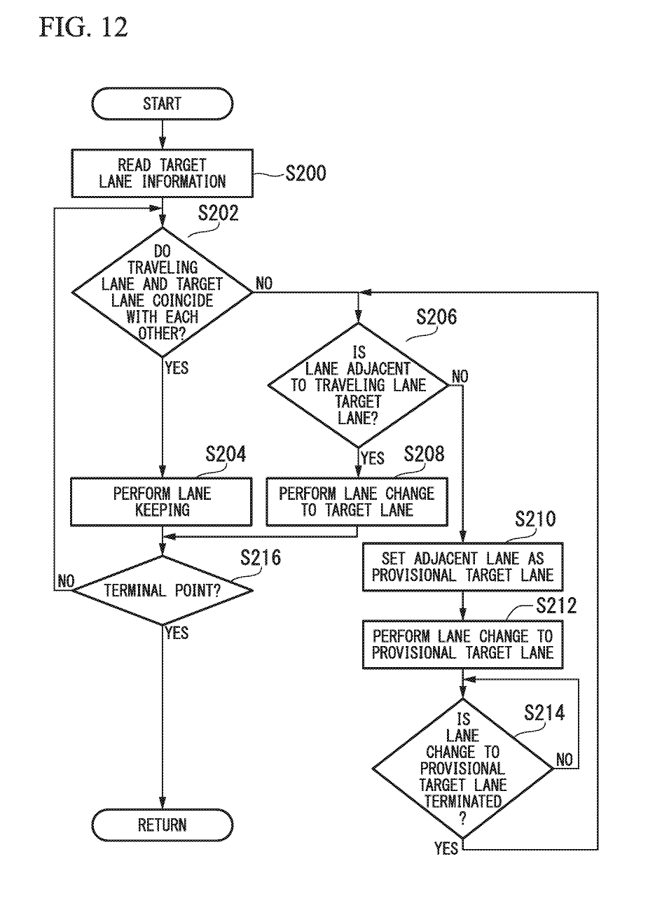

Hereinafter, a series of processings of the automated driving controller 120 according to the embodiment will be described. FIG. 12 is a flowchart showing an example of a flow of the processing of the automated driving controller 120 according to the embodiment.

First, the action plan generating part 126 reads the target lane information 184 per a predetermined blocks B(n) (for example, per 2 km) from the storage 180 (step S200), and determines whether the traveling lane recognized by the own vehicle position recognition part 122 coincides with the target lane set by the target lane information 184 (step S202).

When the traveling lane and the target lane coincide with each other, the automated driving controller 120 performs the lane keeping (step S204).

Meanwhile, when the traveling lane and the target lane do not coincide with each other, the action plan generating part 126 determines whether the adjacent lane close to the traveling lane is the target lane (step S206).

When the adjacent lane is the target lane, the automated driving controller 120 changes the lane of the own vehicle M from the traveling lane to the adjacent lane that is the target lane (step S208).

Meanwhile, when the adjacent lane is not the target lane, since one lane or more is present at least between the traveling lane and the target lane, the action plan generating part 126 sets the adjacent lane therebetween as the provisional target lane (step S210).

Next, the automated driving controller 120 changes the lane of the own vehicle M from the traveling lane to the adjacent lane that is the provisional target lane before the timing the provisional target lane is switched to the original target lane (step S212).

Next, the action plan generating part 126 waits until the lane change to the provisional target lane is terminated (step S214) and returns the processing to the above-mentioned step S206 when the lane change to the provisional target lane is terminated.

Accordingly, in a case the lane is still present between the traveling lane and the target lane, the automated driving controller 120 sets the adjacent lane of the traveling lane as the provisional target lane, and repeats the lane change until the own vehicle arrives at the target lane set by the target lane setting part 110.

Next, the automated driving controller 120 determines whether the current position of the own vehicle M recognized by the own vehicle position recognition part 122 is a terminal point of the blocks B(n) with reference to the target lane information 184 (step S216), and returns to the processing of the above-mentioned step S202 in a case the current position is not the terminal point of the blocks B(n), and terminates the processing of the flowchart when the current position is the terminal point of the blocks B(n).

According to the above-mentioned embodiment, the vehicle control system includes the target lane setting part 110 configured to set the target lane for traveling the own vehicle M among any one of the plurality of lanes without considering a neighborhood relation of the lanes, the action plan generating part 126 configured to set other lane as the provisional target lane in a case the other lane is present between the traveling lane in which the own vehicle M is traveling and the target lane set by the target lane setting part 110, and the controller (for example, the trajectory candidate generating part 134, the lane change controller 138 and the traveling controller 160) configured to automatically control at least the steering of the own vehicle M such that the own vehicle M travels in the target lane or the provisional target lane. Accordingly, the lane in which the own vehicle is traveling can be flexibly selected according to a circumstance during traveling.

As described above, while the aspect for performing the present invention has been described using the embodiment, the present invention is not limited to the above-mentioned embodiment and various modifications and substitutions may be made without departing from the scope of the present invention.

### REFERENCE SIGNS LIST

20 Finder

30 Radar

40 Camera

50 Navigation device

60 Vehicle sensor

62 Display

64 Speaker

70 Operation device

72 Operation detecting sensor

75 Communication device

80 Selector switch

90 Driving force output apparatus

92 Steering apparatus

94 Brake apparatus

100 Vehicle control system

110 Target lane setting part

120 Automated driving controller

122 Own vehicle position recognition part

124 Outside recognition part

126 Action plan generating part

130 Trajectory generating part

132 Traveling state determining part

134 Trajectory candidate generating part

136 Estimation and selection part

138 Lane change controller

160 Traveling controller

170 Switching controller

180 Storage

M Own vehicle

What is claim is:

1.-6. (canceled)

7. A vehicle control system comprising:
a first setting part that sets a target lane for traveling an own vehicle on the basis of a route to a set destination;
a determination part that determines whether a lane is present between a traveling lane in which the own vehicle is traveling and the target lane set by the first setting part;
a second setting part that sets a lane present between the traveling lane and the target lane as a provisional target lane for a temporarily target lane in a case the determination part has determined the presence of the lane; and
a controller that automatically controls at least the steering of the own vehicle such that the own vehicle travels in the target lane set by the first setting part or the provisional target lane set by the second setting part,
wherein the controller automatically controls at least the steering of the own vehicle toward the target lane set by the first setting part under a condition that the determination part has determined a lane between the traveling lane of the own vehicle and the target lane is not present, and
in a case the determination part has determined a lane between the traveling lane of the own vehicle and the target lane is present, the controller automatically controls at least the steering of the own vehicle toward the provisional target lane under a condition that the provisional target lane has been set by the second setting part.

8. The vehicle control system according to claim 7, wherein, in a case the traveling lane of the own vehicle is different from the target lane set by the first setting part or the second setting part, the controller changes the lane of the own vehicle from the traveling lane to the target lane set by the first setting part or the second setting part by automatically controlling at least the steering of the own vehicle.

9. The vehicle control system according to claim 8, wherein the controller changes the lane of the own vehicle to the lane that is temporarily set as the target lane by the second setting part, and then, changes the lane of the own vehicle to the target lane set by the first setting part.

10. The vehicle control system according to claim 7, wherein, in a case the traveling lane of the own vehicle coincides with the target lane, the lane change of the own vehicle is terminated and transfers to a lane keeping mode.

11. A method installed in a computer configured to control a vehicle, the method comprising:
setting a target lane for traveling an own vehicle on the basis of a route to a set destination;
determining whether a lane is present between a traveling lane in which the own vehicle is traveling and the set target lane;
setting a lane present between the traveling lane and the target lane as a provisional target lane for a temporarily target lane in a case it has been determined that a lane is present between a traveling lane of the own vehicle and the target lane; and
automatically controlling at least steering of the own vehicle such that the own vehicle travels in the set target lane or the provisional target lane;
automatically controlling at least the steering of the own vehicle toward the target lane under a condition that it has been determined a lane between the traveling lane of the own vehicle and the target lane is not present; and
in a case it has been determined a lane between the traveling lane of the own vehicle and the target lane is present, automatically controlling at least the steering of the own vehicle toward the provisional target lane under a condition that the provisional target lane has been set.

12. A vehicle control program installed on an in-vehicle computer and configured to:
set a target lane for traveling an own vehicle on the basis of a route to a set destination;
determine whether a lane is present between a traveling lane in which the own vehicle is traveling and the set target lane;
set a lane present between the traveling lane and the target lane as a provisional target lane for a temporarily target lane in a case it has been determined that a lane is present between a traveling lane of the own vehicle and the target lane; and
automatically controlling at least steering of the own vehicle such that the own vehicle travels in the set target lane or the provisional target lane;
automatically controlling at least the steering of the own vehicle toward the target lane under a condition that it has been determined a lane between the traveling lane of the own vehicle and the target lane is not present; and
in a case it has been determined a lane between the traveling lane of the own vehicle and the target lane is present, automatically controlling at least the steering of the own vehicle toward the provisional target lane under a condition that the provisional target lane has been set.
